(19) United States
(12) Patent Application Publication
(10) Pub. No.: US 2014/0372569 A1
(43) Pub. Date: Dec. 18, 2014

(54) CONTROLLING DASH CLIENT RATE ADAPTATION

(71) Applicant: Samsung Electronics Co., Ltd., Suwon-si (KR)

(72) Inventor: Imed Bouazizi, Plano, TX (US)

(73) Assignee: Samsung Electronics Co., Ltd., Suwon-si (KR)

(21) Appl. No.: 14/184,280

(22) Filed: Feb. 19, 2014

Related U.S. Application Data
(60) Provisional application No. 61/835,322, filed on Jun. 14, 2013.

(51) Int. Cl. H04L 29/08

(52) U.S. Cl. CPC H04L 67/02
USPC 709/219

(57) ABSTRACT

Methods and apparatuses for causing changes to DASH client rate adaptation are provided. For example, a method for causing changes to DASH client rate adaptation includes generating a signal to cause changes to rate adaptation behavior of one or more DASH client devices. The method also includes sending the signal to the one or more DASH client devices. As another example, an apparatus includes a DASH client device having a communication unit and a controller. The communication unit is configured to receive a signal. The controller is configured to determine whether modify a rate adaptation behavior of the DASH client device based on the signal.

### CROSS-REFERENCE TO RELATED APPLICATION(S) AND CLAIM OF PRIORITY

The present application claims priority under 35 U.S.C. §119(e) to U.S. Provisional Patent Application Ser. No. 61/835,322 filed Jun. 14, 2013 and entitled “METHOD AND APPARATUS FOR CONTROLLING DASH CLIENT RATE ADAPTATION.” The content of the above-identified patent document is hereby incorporated by reference in its entirety.

### TECHNICAL FIELD

The present application relates generally to media streaming and, more specifically, to controlling rate adaptation behavior of a client in a media streaming network.

### BACKGROUND

Recent developments in media streaming have favored Hypertext Transfer Protocol (HTTP) as the transport protocol for many reasons. HTTP protocol stacks are widely deployed on almost every existing platform. Launching a streaming service with HTTP does not require specialized hardware or software but may be done using existing off-the-shelf servers, such as the open source Apache web server. The usage of HTTP also has the benefit of reusing existing Content Distribution Network (CDN) infrastructures. Furthermore, due to the wide use of HTTP, network address translation (NAT) traversal and firewall issues that other protocols, such as Real-time Transport Protocol (RTP), may encounter are resolved inherently for HTTP.

Several adaptive HTTP streaming solutions have been developed over the past few years. A prominent solution is one standardized by the Moving Pictures Experts Group (MPEG) and 3rd Generation Partnership Project (3GPP) called Dynamic Adaptive Streaming over HTTP (DASH). DASH is a set of technology standards by which devices operate to enable high-quality streaming of media content over networks such as the Internet. DASH defines the formats for media data delivery, as well as the procedures starting from the syntax and semantics of a manifest file called the Media Presentation Description (MPD).

### SUMMARY

Embodiments of the present disclosure provide methods and apparatuses for controlling DASH client rate adaptation.

In one example embodiment, a method for causing changes to DASH client rate adaptation is provided. The method includes generating a signal to cause changes to rate adaptation behavior of one or more DASH client devices. The method also includes sending the signal to the one or more DASH client devices.

In another example embodiment, an apparatus for causing changes to DASH client rate adaptation is provided. The apparatus includes a communication unit and a controller. The controller is configured to generate a signal to cause changes to rate adaptation behavior of one or more DASH client devices. The communication unit is configured to send the signal to the one or more DASH client devices.

In yet another example embodiment, a method for DASH client rate adaptation is provided. The method includes receiving a signal at a DASH client device. The method also includes determining whether to modify a rate adaptation behavior of the DASH client device based on the signal.

In still another example embodiment, an apparatus for DASH client rate adaptation is provided. The apparatus includes a DASH client device having a communication unit and a controller. The communication unit is configured to receive a signal. The controller is configured to determine whether modify a rate adaptation behavior of the DASH client device based on the signal.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless system that transmits messages in accordance with this disclosure;

FIG. 2 illustrates an example transmit path in accordance with this disclosure;

FIG. 3 illustrates an example receive path in accordance with this disclosure;

FIG. 4 illustrates an example structure of a Media Presentation Description (MPD) file in accordance with this disclosure;

FIG. 5 illustrates an example of a segmented ISOBMFF-based content in accordance with this disclosure;

FIG. 6 illustrates an example process for controlling rate adaptation of a DASH client in accordance with this disclosure;

FIG. 7 illustrates an example process for DASH client rate adaptation in accordance with this disclosure; and

FIG. 8 illustrates an example node in which various embodiments of the present disclosure may be implemented.

### DETAILED DESCRIPTION

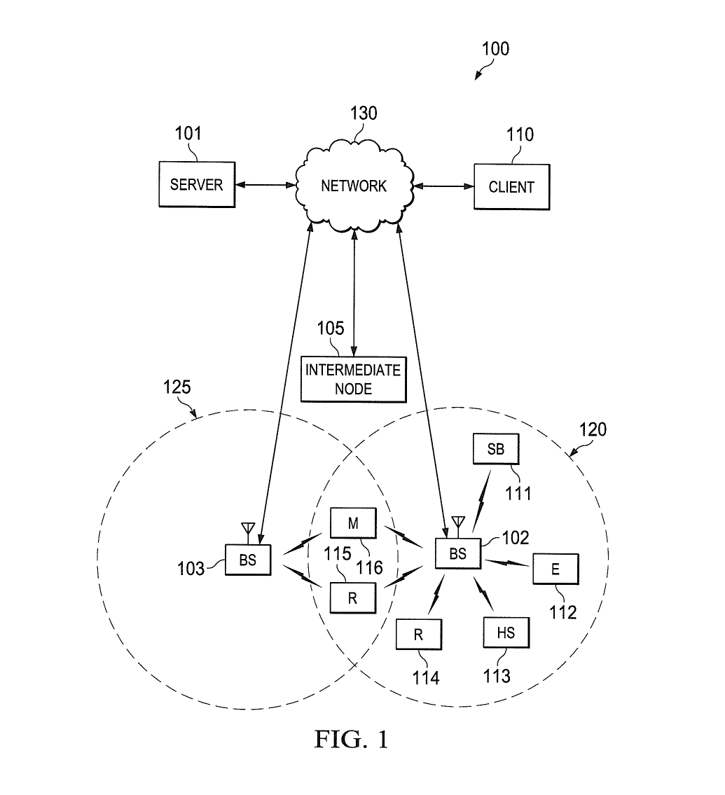

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

Various figures described below may be implemented in wireless communications systems and with the use of OFDM or OFDMA communication techniques. However, the descriptions of these figures are not meant to imply physical or architectural limitations on the manner in which different embodiments may be implemented. Different embodiments of the present disclosure may be implemented in any suitably-arranged communications systems using any suitable communication techniques.

FIG. 1 illustrates an example wireless system 100 that transmits messages in accordance with this disclosure. In the illustrated embodiment, the system 100 includes a server 101, clients 110-116, and a network 130 connecting the server 101 to the clients 110-116. The server 101 could represent a media server, such as an Apache server, an HTTP server, or other type of media content provider. The network 130 could represent the Internet, a media broadcast network, an IP-based communication system, or other suitable network and can include or be coupled to various intermediate nodes that connect the server 101 to the clients 110-116. The intermediate nodes may include wireless transmission points. Specific examples can include eNodeBs (eNBs) 102-103 or other base stations, network service provider nodes, gateways, intermediate servers (such as company or organization servers), relay stations, or access points. Clients 110-116 are in communication with the server 101 via the network 130 and the intermediate nodes. For example, the clients 110-116 may receive streamed media data from the server 101 using DASH standards and protocols in accordance with the teachings of the present disclosure. Although one server 101 is illustrated, multiple such servers may be present in the system 100. The intermediate nodes may also include a wired intermediate node 105.

In accordance with example wireless communication embodiments, the eNB 102 provides wireless broadband access to the network 130 to a first plurality of user equipments (UEs) within a coverage area 120 of the eNB 102. The first plurality of UEs includes UE 111, which may be located in a small business (SB); UE 112, which may be located in an enterprise (E); UE 113, which may be located in a WiFi hotspot (HS); UE 114, which may be located in a first residence (R); UE 115, which may be located in a second residence (R); and UE 116, which may be a mobile device (M), such as a cell phone, a wireless laptop, a wireless PDA, or the like. The eNB 103 provides wireless broadband access to the network 130 to a second plurality of UEs within a coverage area 125 of the eNB 103. The second plurality of UEs includes UE 115 and UE 116. In example embodiments, the eNBs 102-103 may communicate with each other and with UEs 111-116 using OFDM or OFDMA techniques.

While only six UEs are depicted in FIG. 1, the system 100 may provide wireless broadband access to additional UEs. Also, the UEs 115-116 are located on the edges of both coverage areas 120-125. UE 115 and UE 116 can therefore each communicate with both eNBs 102-103 and be said to be operating in handoff mode as known to those of skill in the art.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

The clients 110-116 may access voice, data, video, video conferencing, and/or other broadband services via the network 130. In example embodiments, one or more of the clients 110-116 may be associated with an access point (AP) of a WiFi WLAN.

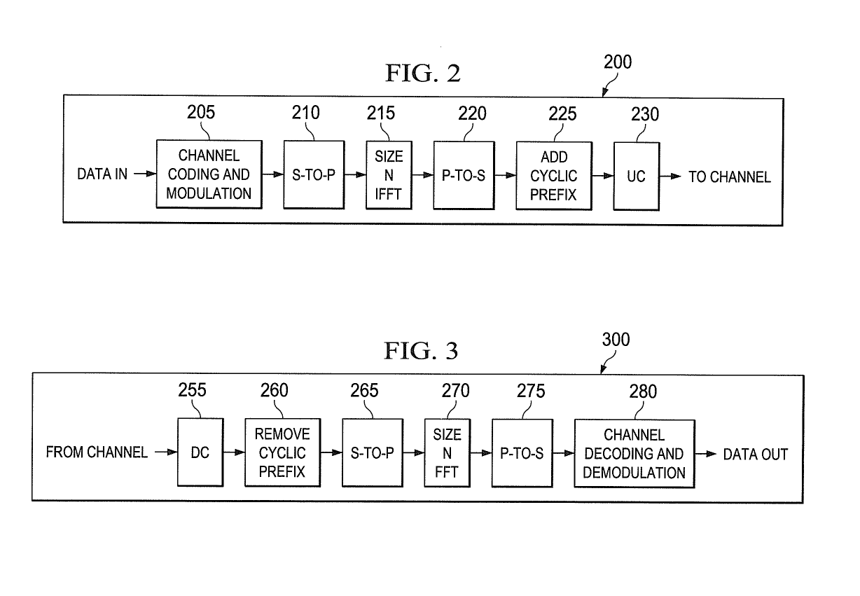

FIG. 2 illustrates an example transmit path 200 in accordance with this disclosure. In some embodiments, the transmit path 200 may be used for OFDMA communications. FIG. 3 illustrates an example receive path 300 in accordance with this disclosure. In some embodiments, the receive path 300 may also be used for OFDMA communications.

In FIGS. 2 and 3, for downlink communication, the transmit path 200 may be implemented in an eNB (such as eNB 102), and the receive path 300 may be implemented in a UE (such as UE 116). For uplink communication, the receive path 300 may be implemented in an eNB (such as eNB 102), and the transmit path 200 may be implemented in a UE (such as UE 116).

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the eNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the eNB 102 arrives at the UE 116 after passing through the wireless channel, and reverse operations to those at the eNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, could be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

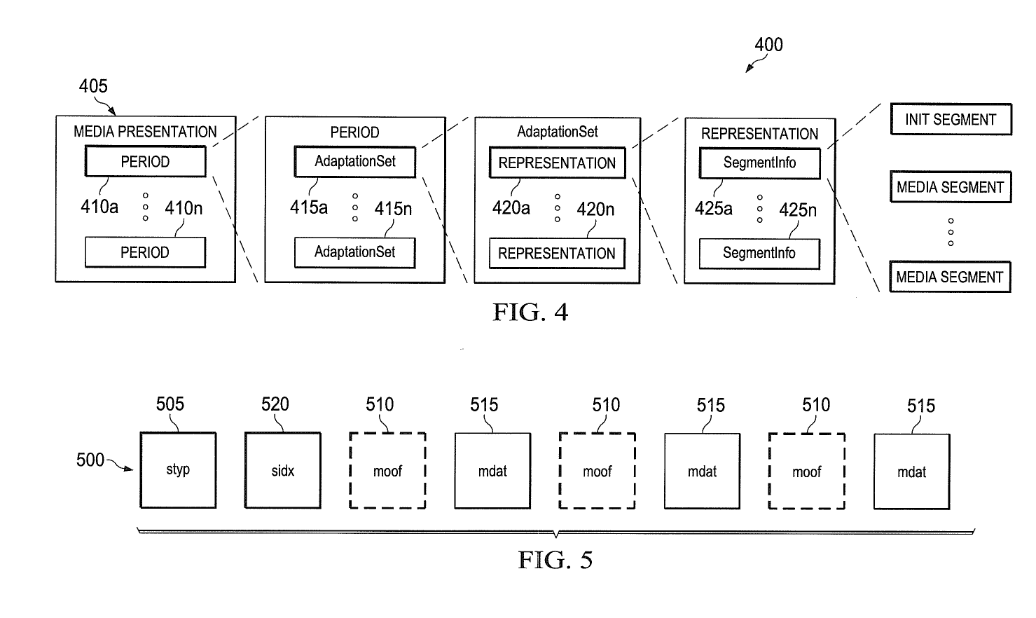

FIG. 4 illustrates an example structure of a Media Presentation Description (MPD) file 400 in accordance with this disclosure. In DASH, the MPD file 400 is a manifest file that describes how to access media data of a presentation and how to provide annotations for the different content components to help a receiver or end user with content selection.

As shown in FIG. 4, an MPD file 400 describes a media presentation 405, which is divided into a set of consecutive time periods 410a-410n. Each period 410a-410n includes a set of media components that are defined as adaptation sets 415a-415n. For a specific component, an adaptation set 415a-415n includes a set of representations 420a-420n, each of which is a different encoding of the same media component (such as with different bitrates, codecs, or formats). Each representation 420a-420n may be fetched and streamed separately. In order to simplify media streaming, each representation 420a-420n may be divided into one or more media segments 425a-425n. A representation 420a-420n in the MPD file 400 describes the characteristics for that specific encoding of the content component (such as the bitrate, codec, or format). Additionally, a representation 420a-420n provides access information for each segment 425a-425n of that content representation. The MPD file 400 assumes that the segments are accessible using HTTP uniform resource locators (URLs) and optionally byte ranges inside the referenced resources. A template construction is provided to avoid referencing each single segment with its own URL in the MPD file 400. Furthermore, the segments 425a-425n can be indexed starting from index 1 and incrementing by 1 for each subsequent segment.

DASH defines at least two different media data formats, one based on the International Organization for Standardization Base Media File Format (ISOBMFF) and one based on the MPEG-2 Transport System (M2TS).

FIG. 5 illustrates an example of a segmented ISOBMFF-based content in accordance with this disclosure. In the ISOBMFF-based format, a DASH representation is a compliant ISOBMFF file that has the characteristic of being fragmented, meaning the media data of the file is provided in fragments. Fragmentation has a benefit when it comes to low delay operation, which is important in streaming applications.

As shown in FIG. 5, a media segment 500 in the ISOBMFF-based format is identified using a segment type (in a styp box 505) and includes one or more movie fragments and the associated media data (in respective moof 510 and mdat boxes 515). The moof box 510 contains the metadata and seeking information for a media fragment, while the mdat box 515 includes the media fragments (such as audio or video frames). To simplify access and navigation of media segments, a segment index is provided (via sidx box 520), which indexes Random Access Points (RAPs) and movie fragments of that particular segment 500. This indexing is particularly useful to enable clients to perform arbitrary representation switching within an adaptation set while maintaining a seamless user experience, accurate media synchronization, and continuous playback.

As noted above, another format defined in DASH is based on M2TS, where an MPEG-2 elementary stream corresponds to a representation. The available representations are multiplexed into the main M2TS. Segmentation may be performed to simplify delivery of the MPEG-2 TS.

Embodiments of the present disclosure recognize that the difference between adaptive HTTP streaming solutions and progressive download lies in the ability of adaptive HTTP streaming solutions to react to congestion situations and throughput variations and adapt their bitrates accordingly. In progressive download, a media file containing a single representation of content is downloaded by a client. Multiple encodings may exist, but no appropriate description and selection mechanisms are provided for progressive download, which limits selection of the appropriate representation of the content at the start of the session through an external mechanism (such as user selection).

Embodiments of the present disclosure recognize that, in DASH, each media component of the content is provided as part of an adaptation set. An adaptation set includes one or more representations of the same content, among which the DASH client may select one at any time of the streaming session. A DASH client adapts to network conditions by switching to a representation that fits within the overall throughput budget. Embodiments of the present disclosure recognize that DASH rate adaptation is client-driven; however, the accuracy of the rate adaptation is governed by the presentation author (such as a media server and/or a network), which controls the number of operation points from which the DASH client chooses.

A DASH client may monitor throughput and the level of one or more media buffers in the DASH client and decide whether to switch representations and, if so, which representation to select. For example, a DASH client may use the “segment download time to segment duration” ratio as an indication of whether the available throughput is lower, equal to, or higher than the bandwidth needed by the representation of which the media segment is being downloaded. A value higher than 1.0 indicates that the DASH client takes more time to download a media segment than the amount of media provided by that media segment. This is indicative of a possible forthcoming playback problem since the media reception rate is lower than the media consumption rate, which will drain the media buffer. A DASH client then may choose to switch to a representation with lower bandwidth requirements.

DASH relies on clients to perform rate adaptation by switching between the representations that are provided by a content provider. However, intermediate nodes, such as those run by mobile operators, often need to adjust the bitrates of existing connections to deal with short- or long-term overload of a particular cell or area in a core network to promote network use efficiencies. Two different approaches have been proposed to resolve this issue. In a first approach, an intermediate node may throttle the bandwidth of a connection by delaying or dropping packets of the flow that carries Transport Control Protocol/Internet Protocol (TCP/IP) packets of a DASH session. As a consequence, TCP adjusts the transmission rate to the available throughput, and the DASH client later adjusts by switching based on the reduced bandwidth. This approach may be less than optimal because it forces retransmissions to recover lost packets and increases management overhead associated with throttling connections.

In a second approach, intermediate nodes intercept requests for manifest files (MPD files 400) and re-author the MPD files by removing representations that require higher bandwidth. However, this approach may have several drawbacks. For example, re-authoring an MPD file mixes up MPD update timelines since two sources are involved in the authoring of the MPD file. For on-demand services, the original MPD file may not foresee any updates to the MPD file, and DASH clients will not be seeking updates to the MPD file. The complexity of the processing may also be significant as intermediate nodes will need to parse and re-author the MPD files.

Accordingly, embodiments of the present disclosure provide methods and apparatuses for controlling the rate adaptation procedures at a DASH client 110-116. Embodiments of the present disclosure use the DASH event framework and define a set of rate control events or signals to control or modify rate adaptation procedures at the DASH client.

After issuing an MPD file, the server 101, the network 130, or an intermediate node (such as node 105) may prefer certain representations. For example, the network 130 may have a cache with a copy of certain representation(s) of media content. The network 130 may prefer the client 110-116 use the cached representation(s) for network efficiency and congestion reduction, which may also be beneficial for the client (such as in latency reduction). In another example, an operator of the network 130 or server 101 may detect resource congestion and desire the DASH client 110-116 to use a lower bandwidth representation. In yet another example, a selected set of representations can be delivered over enhanced multimedia broadcast multicast service (eMBMS), and the operator of the network 130 or server 101 may prefer eMBMS delivery to the DASH client. Additional examples of factors influencing the server 101, the network 130, or the intermediate node 105 representation preferences include buffer sizes, server status, and preferred URLs.

In various embodiments, the server 101 or the intermediate node 105 inserts events or sends signals to guide a DASH client 110-116 in rate adaptation. In example embodiments, the intermediate node 105 may intercept and include the control signal as part of one or more DASH segments and/or provide the signal as a DASH event. In other example embodiments, the intermediate node 105 may send a control signal over a communication channel that is separate from the communication channel that the DASH client receives an MPD file or media content. In various examples, the control signal may indicate that specific representation(s) are unavailable temporarily, such as because of bandwidth availability, server status, or buffer constraints. In other examples, the control signal may indicate that specific representation(s) are preferred for consumption, such as because of cache copy availability or bandwidth utilization of these representation(s). In still other examples, the control signal may indicate that a particular representation is now available over a channel or network that is different from the channel or network presently used to deliver representations to the client.

In example embodiments, an event is defined to deliver a rate control signal. A scheme URI may be defined for this purpose, such as “urn:mpeg:dash:control:2013.” Each rate control message may include a value and may include additional information. Table 1 below describes a set of possible control signals, semantics of the control signals, and the content indicated by the control signals.

TABLE 1

| Value | Description | Message Data |
|---|---|---|
| 1 | Representation | A representation is temporarily not available for consumption. |
| | temporarily | The message data contains the representation identifier |
| | unavailable | “Representation@id” or it may refer to the |
| | | current representation. |
| 2 | Representation | A representation is permanently made unavailable and the |
| | permanently | DASH client should avoid using this representation in the future. |
| | unavailable | The message data may contain the representation identifier or it |
| | | may refer to the current representation. |
| 3 | Representation | A representation is available again after it has been made temporarily |
| | available | unavailable. The message data may contain the representation identifier. |
| 4 | Preferred | A representation is recommended to the DASH client over other |
| | Representation | representations of the same AdaptationSet. The message data carries |
| | | the representation identifier. |
| 5 | Available | The network estimates or guarantees a certain bandwidth for the |
| | Throughput or | DASH client and expects the client to perform rate adaptation in |
| | Bandwidth | accordance with this recommendation. The message data may contain |
| | | the available bandwidth or throughput in bits per second or in some other unit. |

In example embodiments, an event message may be defined according to the DASH specification ISO/IEC 23009-1 Amendment 1 (which is hereby incorporated by reference in its entirety) using a message structure as follows:

```
aligned(8) class EventMessageBox extends FullBox(‘emsg’,
version = 0, flags = 0){
string scheme_id_uri;
    string value;
    unsigned int(32) timescale;
    unsigned int(32) presentation_time_delta;
    unsigned int(32) event_duration;
    unsigned int(32) id;
    unsigned int(8) message_data[ ];
}
```

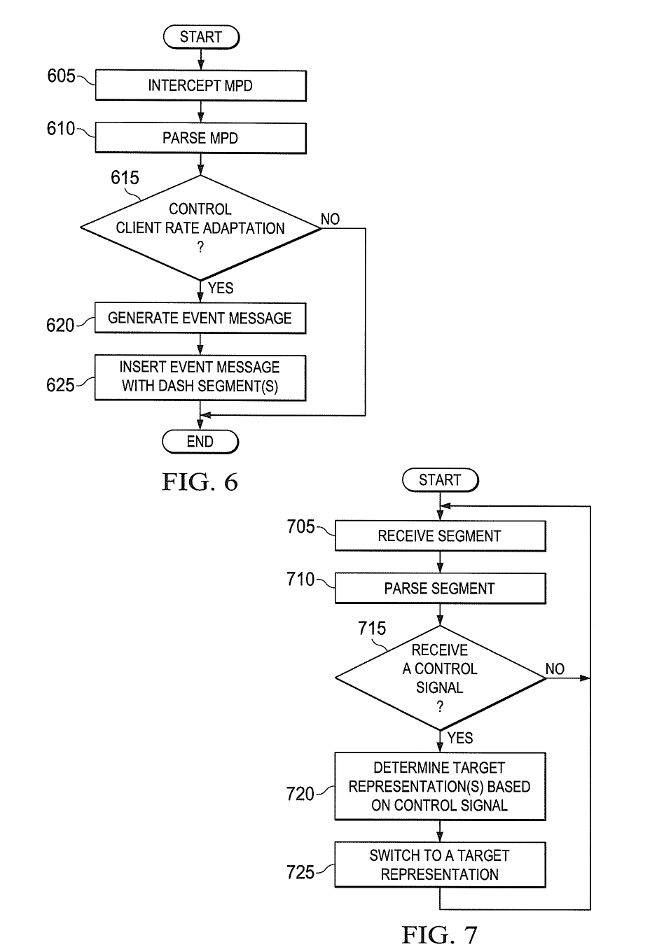

FIG. 6 illustrates an example process for controlling rate adaptation of a DASH client in accordance with this disclosure. For ease of explanation, the process depicted in FIG. 6 may be performed by the server 101 or any intermediate node (such as eNB 102, eNB 103, or node 105) in FIG. 1.

The process begins with a node intercepting an MPD file (step 605) and parsing the MPD file (step 610). For example, as part of these steps, the intermediate node 105 may receive the MPD file and determine from the MPD file which representations are made available for a client 110-116 to stream. When the server 101 affects rate adaptation control, steps 605-610 may not be performed since the server 101 may know the available representations without needing to intercept and parse any MPD files.

The node determines whether to control client rate adaptation (step 615). For example, as part of this step, the server 101 and/or the intermediate node 105 may determine whether certain representations are unavailable, not preferred, or preferred. This could be based on bandwidth budget goals for a streaming session, where the bandwidth budget goals are based on network conditions, cache copy availability, server or buffer status, or other or additional factors.

If the node determines not to control client rate adaptation, the process may end. If, however, the node determines to control client rate adaptation, the node may generate an event message (step 620) and insert the event message with one or more DASH segment(s) (step 625). For example, as part of these steps, the node may generate an event message according to the format and content shown in Table 1. The event message may be a DASH event. In embodiments where the control signal is transmitted separately, step 620 may not be performed, and the node may send the generated event message as a rate control signal to the client.

Upon sending the event message in step 625, the process may end. The node may continue to monitor for MPD transmissions, network conditions, and/or monitor representations streamed over the network to determine compliance with representation selections and/or to determine whether to send additional control signals (such as based on changed network conditions).

FIG. 7 illustrates an example process for DASH client rate adaptation in accordance with this disclosure. For ease of explanation, the process depicted in FIG. 7 may be performed by a DASH client 110 in FIG. 1.

The process begins with the client 110 receiving a segment (step 705) and parsing the segment (step 710). For example, as part of these steps, the client 110 may receive a media segment. The client 110 determines whether a control signal is received (step 715). For example, as part of this step, the client 110 may determine whether the control signal is present as a DASH event control message in the received segment. In embodiments where the control signal is transmitted separately, the client 110 may receive the control signal separately from the media segments and may determine whether a rate control message is received before or after receipt of any media segments. In other examples, the client 110 may receive the control signal as part of an MPD file, such as an MPD file generated by the server 101.

If the client 110 does not receive a rate control signal, the client continues to receive media segments while streaming media content. If, however, the client 110 receives the control signal, the client 110 determines the target representation(s) based on the control signal (step 720). For example, as part of this step, the control signal may specify the target representation(s). In other examples, the control signal may specify target representation(s) that are currently unavailable, and the client 110 may determine the target representation(s) from the remaining available representations. In yet other examples, the control signal may specify a bandwidth budget, and the client 110 may determine the target representation(s) based on which meet the specified bandwidth budget.

The client switches to a target representation if it is not already using the target representation (step 725). For example, as part of this step, if more than one target representation is available after application of the server/network constraints/preferences indicated by the control signal, the client 110 may select the target representation based on the information included in the control signal and possibly information about the client device. Information about the client device could include buffer/bandwidth capacity, preferred codecs, and media quality/network utilization preferences. If not already using the selected representation, the client 110 switches to the selected representation. In example embodiments, the event control message may include an event timestamp for using the indicated representation, and the client 110 may switch to the indicated representation on or before the time indicated in the timestamp, such as to avoid disruptions in streaming the media content. The client continues to monitor for control signals and network conditions in performing rate adaptation for smooth and efficient streaming of the media content.

Although FIGS. 6 and 7 illustrate examples of different processes, various changes could be made to FIGS. 6 and 7. For example, while shown as a series of steps, various steps in each figure could overlap, occur in parallel, occur in a different order, or occur multiple times.

Embodiments of the present disclosure enable efficient and clean communications between DASH clients and network nodes by allowing upstream (server and network) nodes to suggest a selection of representation(s). These suggestions may or may not be required to be followed by the clients. The network is enabled to indicate a preference for specific representation(s) to the DASH client without interfering with the MPD file. Embodiments of the present disclosure also enable efficient and streamlined cooperation between a network and a client to select mutually beneficial operations in media streaming

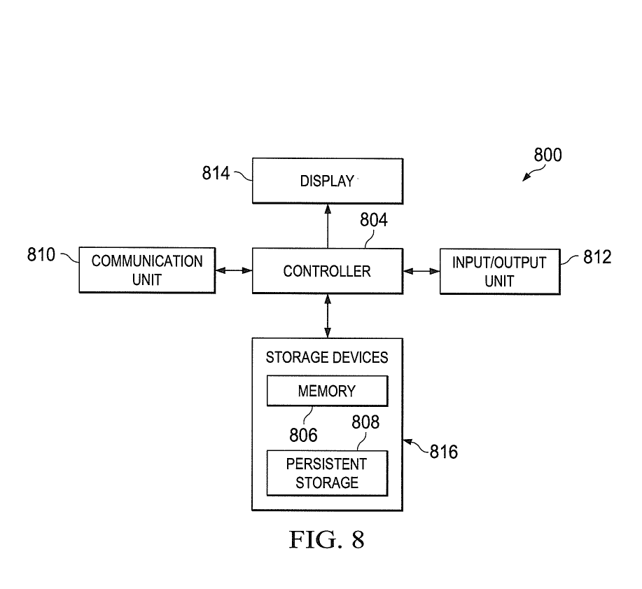

FIG. 8 illustrates an example node 800 in which various embodiments of the present disclosure may be implemented. The node 800 shown here could represent one example implementation of the server 101, the eNBs 102-103, the intermediate node 105, and/or the clients 110-116 in FIG. 1.

In this example, the node 800 includes a controller 804, a memory 806, a persistent storage 808, a communication unit 810, an input/output (I/O) unit 812, and a display 814. The controller 804 is any device, system, or part thereof that controls at least one operation, and such a device may be implemented in hardware or a combination of hardware and firmware and/or software. For example, the controller 804 may include a hardware processing unit, processing circuitry, media coding and/or decoding hardware and/or software, and/or a software program configured to control operations of the node 800. As a specific example, the controller 804 may process software instructions that are loaded into the memory 806. The controller 804 may include a number of processors, a multi-processor core, or some other type of processor(s) depending on the particular implementation. Further, the controller 804 may be implemented using a number of heterogeneous processor systems in which a main processor is present with secondary processors on a single chip. As another illustrative example, the controller 804 may include a symmetric multi-processor system containing multiple processors of the same type.

The memory 806 and the persistent storage 808 are examples of storage devices 816. A storage device is any piece of hardware that is capable of storing information, such as data, program code in functional form, and/or other suitable information either on a temporary basis and/or a permanent basis. The memory 806 may be, for example, a random access memory or any other suitable volatile or non-volatile storage device. The persistent storage 808 may contain one or more components or devices such as a hard drive, a flash memory, an optical disk, or some combination of the above. The media used by the persistent storage 808 also may be removable. For example, a removable hard drive may be used for the persistent storage 808.

The communication unit 810 provides for communications with other data processing systems or devices. For example, the communication unit 810 may include a wireless (cellular, WiFi, etc.) transmitter, receiver, and/or transceiver, a network interface card, and/or any other suitable hardware for sending and/or receiving communications over a physical or wireless communications medium. The communication unit 810 may provide communications through the use of physical and/or wireless communications links.

The input/output unit 812 allows for input and output of data with other devices that may be connected to or a part of the node 800. For example, the input/output unit 812 may include a touch panel to receive touch user inputs, a microphone to receive audio inputs, a speaker to provide audio outputs, and/or a motor to provide haptic outputs. The input/output unit 812 is one example of a user interface for providing and delivering media data to a user of the node 800. In other examples, the input/output unit 812 may provide a connection for user input through a keyboard, a mouse, an external speaker, an external microphone, and/or some other suitable input/output device. Further, the input/output unit 812 may send output to a printer. The display 814 provides a mechanism to display information to a user and is one example of a user interface for providing and delivering media data to a user of the node 800.

Program code for an operating system, applications, or other programs may be located in the storage devices 816, which are in communication with the controller 804. In some embodiments, the program code is in a functional form on the persistent storage 808. These instructions may be loaded into the memory 806 for processing by the controller 804. The processes of the different embodiments may be performed by the controller 804 using computer-implemented instructions, which may be located in the memory 806. For example, the controller 804 may perform processes for one or more of the modules and/or devices described above.

Although the present disclosure has been described with an example embodiment, various changes and modifications may be suggested to one skilled in the art. It is intended that the present disclosure encompass such changes and modifications as fall within the scope of the appended claims.

What is claimed is:

1. A method comprising:
generating a signal to cause changes to rate adaptation behavior of one or more Dynamic Adaptive Streaming HTTP (DASH) client devices; and
sending the signal to the one or more DASH client devices.

2. The method of claim 1, further comprising:
receiving a media presentation description (MPD) file for media to be streamed to the one or more DASH client devices; and
determining whether to change the rate adaptation behavior based on at least the MPD file.

3. The method of claim 1, wherein the signal to cause changes to the rate adaptation behavior indicates that one or more representations are disabled at least temporarily to cause the one or more DASH client devices to switch to another representation.

4. The method of claim 1, wherein the signal indicates one or more preferred representations for the one or more DASH client devices to stream.

5. The method of claim 1, wherein the signal indicates a bandwidth budget available for media streaming.

6. The method of claim 1, wherein the signal is sent using a first communication channel or network and indicates that one or more representations are available over a second communication channel or network.

7. The method of claim 1, wherein the signal is included in one or more DASH segments.

8. An apparatus comprising:
a controller configured to generate a signal to cause changes to rate adaptation behavior of one or more Dynamic Adaptive Streaming HTTP (DASH) client devices; and
a communication unit configured to send the signal to the one or more DASH client devices.

9. The apparatus of claim 8, wherein:
the communication unit is configured to receive a media presentation description (MPD) file for media to be streamed to the one or more DASH client devices;
the controller is configured to determine whether to change the rate adaptation behavior based on at least the MPD file.

10. The apparatus of claim 8, wherein the signal to cause changes to the rate adaptation behavior indicates that one or more representations are disabled at least temporarily to cause the one or more DASH client devices to switch to another representation.

11. The apparatus of claim 8, wherein the signal indicates one or more preferred representations for the one or more DASH client devices to stream.

12. The apparatus of claim 8, wherein the signal indicates a bandwidth budget available for media streaming.

13. The apparatus of claim 8, wherein:
the communication unit is configured to send the signal using a first communication channel or network; and
the signal indicates that one or more representations are available over a second communication channel or network.

14. The apparatus of claim 8, wherein the communication unit is configured to include the signal in one or more DASH segments.

15. An apparatus comprising:
a Dynamic Adaptive Streaming HTTP (DASH) client device comprising:
a communication unit configured to receive a signal; and
a controller configured to determine whether modify rate adaptation behavior of the DASH client device based on the signal.

16. The apparatus of claim 15, wherein the controller is configured to identify the signal as a DASH event.

17. The apparatus of claim 15, wherein the controller is configured to determine, from the signal, that one or more representations are disabled at least temporarily and to switch to another representation.

18. The apparatus of claim 15, wherein the controller is configured to determine, from the signal, one or more preferred representations to stream.

19. The apparatus of claim 15, wherein the controller is configured to determine, from the signal, a bandwidth budget available for media streaming.

20. The apparatus of claim 15, wherein communication unit is configured to receive the signal in one or more DASH segments.
